(19) United States
(12) Patent Application Publication
(10) Pub. No.: US 2026/0107208 A1
(43) Pub. Date: Apr. 16, 2026

(54) PREVENTING RRC RE-ESTABLISHMENT VIA RRC RESUME

(71) Applicant: INTERDIGITAL PATENT HOLDINGS, INC., Wilmington, DE (US)

(72) Inventors: Oumer Teyeb, Montreal (CA); Faris Alfarhan, Montreal (CA); Dylan Watts, Montreal (CA); Paul Marinier, Brossard (CA); Brian Martin, Farnham (GB)

(73) Assignee: INTERDIGITAL PATENT HOLDINGS, INC., Wilmington, DE (US)

(21) Appl. No.: 19/116,736

(22) PCT Filed: Sep. 28, 2023
(86) PCT No.: PCT/US2023/034034

§ 371 Date: Mar. 28, 2025

Related U.S. Application Data
(60) Provisional application No. 63/410,962, filed on Sep. 28, 2022.

(51) Int. Cl. H04W 36/30; H04W 76/19

(52) U.S. Cl. CPC H04W 36/305; H04W 76/19

(57) ABSTRACT

The present system and method provide mobility enhancements, network energy savings, RRC Re-establishment, and RRC Resume. For example, a WTRU in CONNECTED state configured to perform RRC Resume procedure (e.g., provided with resume identity, next hop chaining count, etc.), upon detecting the fulfilment of triggering conditions, such as RLF. For example, a WTRU configured to perform the Resume procedure if the is a cell within a certain configured group of cells (e.g., alternate/equivalent cells) that satisfies a condition (e.g., signal level above a certain threshold), For example, a WTRU, upon performing RRC Resume procedure while in CONNECTED mode, being provided with parameters for subsequent resume (e.g., new resume identity, next hop chaining count, etc.), and/or candidate cells that can be used for resumption (e.g., new/updated list of alternate/equivalent cells). For example, a WTRU performing the RRC Resume procedure at an alternate/equivalent cell, using small data transmission (SDT) resources.

### CROSS REFERENCE TO RELATED APPLICATIONS

This application claims the benefit of U.S. Provisional Application Ser. No. 63/410,962, filed Sep. 28, 2022, which is incorporated by reference as if fully set forth.

### BACKGROUND

As described herein, NES via power level control of the serving cell or even turning it off. However, this may have repercussions on WTRU performance. For example, if a cell is turned off, a multitude of WTRUs may detect RLF and initiate RRC re-establishment. Such a behavior is highly undesirable from both the WTRUs and the network perspective. For the WTRU, re-establishment may cause a considerable service interruption because most of the WTRU context is released, the PDCP/RLC is re-established, MAC is reset, etc. For the network, re-establishment, especially when several WTRUs trigger it, may cause high signaling overhead (both at the air interface for full reconfiguration, and possible X2 interactions between source and target, if the WTRU context is to be fetched in order to avoid involving CN). Also, when several WTRUs attempt re-establishment at the same time, RACH collisions during initial access attempt at the target cell(s) by multiple WTRUs at once may further delay the re-establishment and exacerbate the service interruption.

### SUMMARY

The present system and method provide mobility enhancements, network energy savings, RRC Re-establishment, and RRC Resume. For example, a WTRU in CONNECTED state configured to perform RRC Resume procedure (e.g., provided with resume identity, next hop chaining count, etc.), upon detecting the fulfilment of triggering conditions, such as RLF. For example, a WTRU configured to perform the Resume procedure if the is a cell within a certain configured group of cells (e.g., alternate/equivalent cells) that satisfies a condition (e.g., signal level above a certain threshold), For example, a WTRU, upon performing RRC Resume procedure while in CONNECTED mode, being provided with parameters for subsequent resume (e.g., new resume identity, next hop chaining count, etc.), and/or candidate cells that can be used for resumption (e.g., new/updated list of alternate/equivalent cells). For example, a WTRU performing the RRC Resume procedure at an alternate/equivalent cell, using small data transmission (SDT) resources.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a basic handover procedure in NR;

FIG. 3 illustrates a conditional handover configuration and execution;

FIG. 4 illustrates RLM and RLF detection mechanisms;

FIG. 5 illustrates a high-level overview of the re-establishment procedure;

FIG. 6 illustrates an example of L1/2 inter-cell mobility operation, whereby the candidate cell group is configured by RRC and a dynamic switch of PCell and SCell is achieved using L1/2 signaling;

FIG. 7 illustrates an example RRC connection setup procedure;

FIG. 8 illustrates an example RRC connection setup procedure;

FIG. 9 illustrates the different RRC states and the transitions that may occur;

FIG. 10 illustrates a signaling diagram of a WTRU in CONNECTED state configured to perform RRC Resume procedure (e.g., provided with resume identity, next hop chaining count, etc.), upon detecting the fulfilment of triggering conditions, such as RLF;

FIG. 11 illustrates a signaling diagram of a WTRU in CONNECTED state configured to perform RRC Resume procedure (e.g., provided with resume identity, next hop chaining count, etc.), upon detecting the fulfilment of triggering conditions, such as RLF;

FIG. 12 illustrates a signaling diagram of a WTRU in CONNECTED state configured to perform RRC Resume procedure (e.g., provided with resume identity, next hop chaining count, etc.), upon detecting the fulfilment of triggering conditions, such as RLF; and

FIG. 13 illustrates a method for performing RRC Resume procedure according to an aspect.

### DETAILED DESCRIPTION

A system, method and device are described for preventing RRC re-establishment via RRC resume.

The method performed in a wireless transmit receive unit (WTRU) include receiving configuration information for performing a connection resumption upon detection of a radio link failure (RLF), the configuration information at least including a list of candidate cells and an acceptable threshold signal level for a cell to be used, and upon detection of an RLF, performing cell selection towards one of the candidate cells included in the list of candidate cells with radio conditions that meet the threshold and initiating a connection resumption procedure by sending a connection resume request message to a network. The method may include the receiving in CONNECTED state. The information may further include one or more of WTRU identity to be used during the connection resumption procedure and a security configuration to be applied during the connection resumption procedure. The method may include using a cause value in the connection resume request, the cause value indicating at least one reason that triggered the connection resumption. The method may include receiving a connection resume message from the network, the connection resume message including configuration information. The method may include applying the configuration information. The method may include resuming the connection with the network via a selected candidate cell. The method may include sending a connection resume complete message to the network. The connection resume complete message indicates that the WTRU has resumed the connection. The method may include performing a re-establishment procedure if there are no cells included in the list of candidate cells that meet the threshold. The method may include determining the radio conditions of one of the candidate cells from the list of candidate cells meets the threshold.

The wireless transmit receive unit (WTRU) includes a processor and a transceiver communicatively coupled to the processor. The processor and transceiver operating to receive configuration information for performing a connection resumption upon detection of a radio link failure (RLF), the configuration information at least including a list of candidate cells and an acceptable threshold signal level for a cell to be used, and upon detection of an RLF, perform cell selection towards one of the candidate cells included in the list of candidate cells with radio conditions that meet the threshold and initiate a connection resumption procedure by sending a connection resume request message to a network. The receiving may be in CONNECTED state. The information may further includes one or more of WTRU identity to be used during the connection resumption procedure and a security configuration to be applied during the connection resumption procedure. The processor and transceiver may further operate to include cause value in the connection resume request, the cause value indicating at least one reason that triggered the connection resumption. The processor and transceiver further operate to receive a connection resume message from the network, the connection resume message including configuration information, apply the configuration information, and resume the connection with the network via a selected candidate cell. The processor and transceiver may further operate to send a connection resume complete message to the network. The connection resume complete message indicates that the WTRU has resumed the connection. The processor and transceiver may further operate to perform a re-establishment procedure if there are no cells included in the list of candidate cells that meet the threshold. The processor and transceiver may further operate to determine the radio conditions of one of the candidate cells from the list of candidate cells meets the threshold.

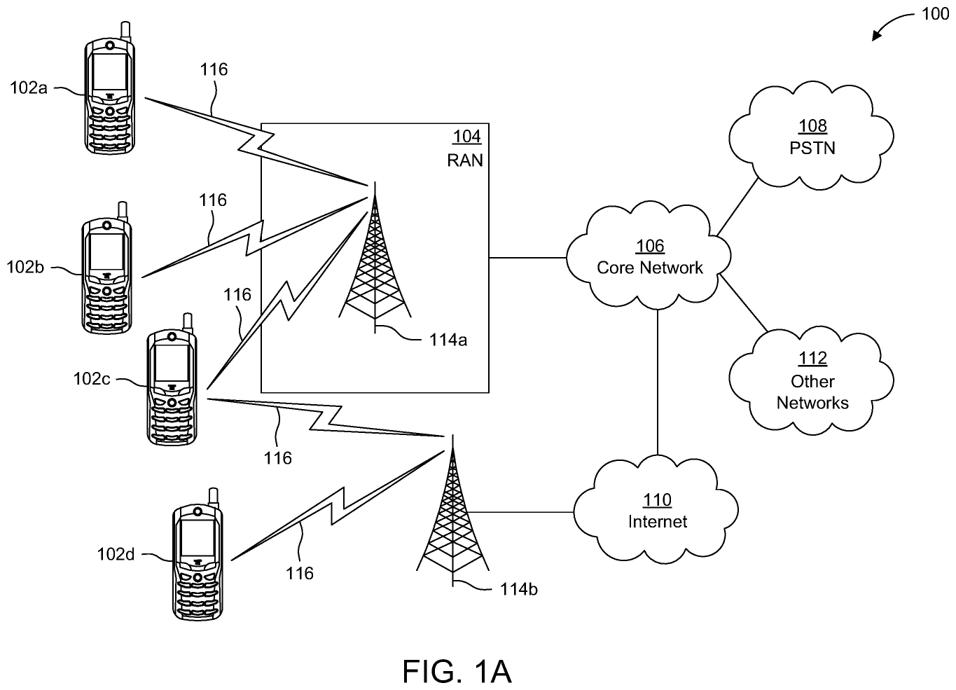

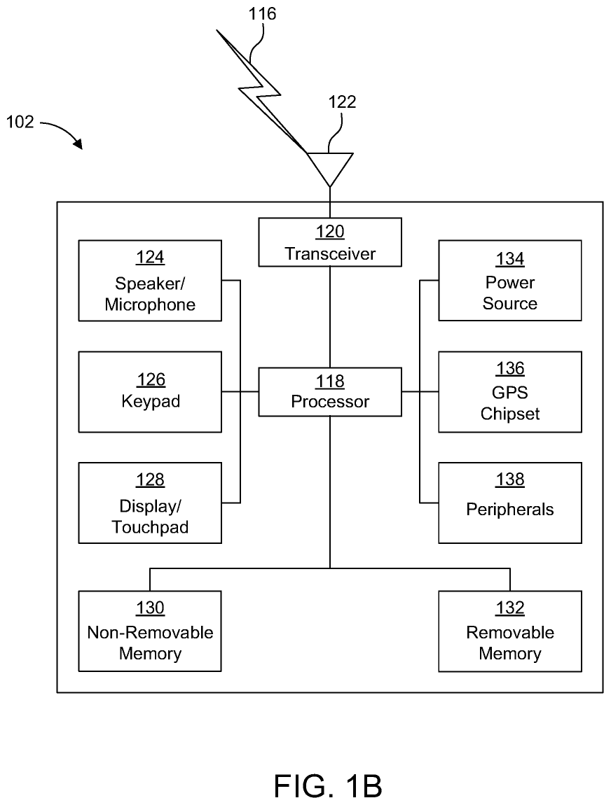

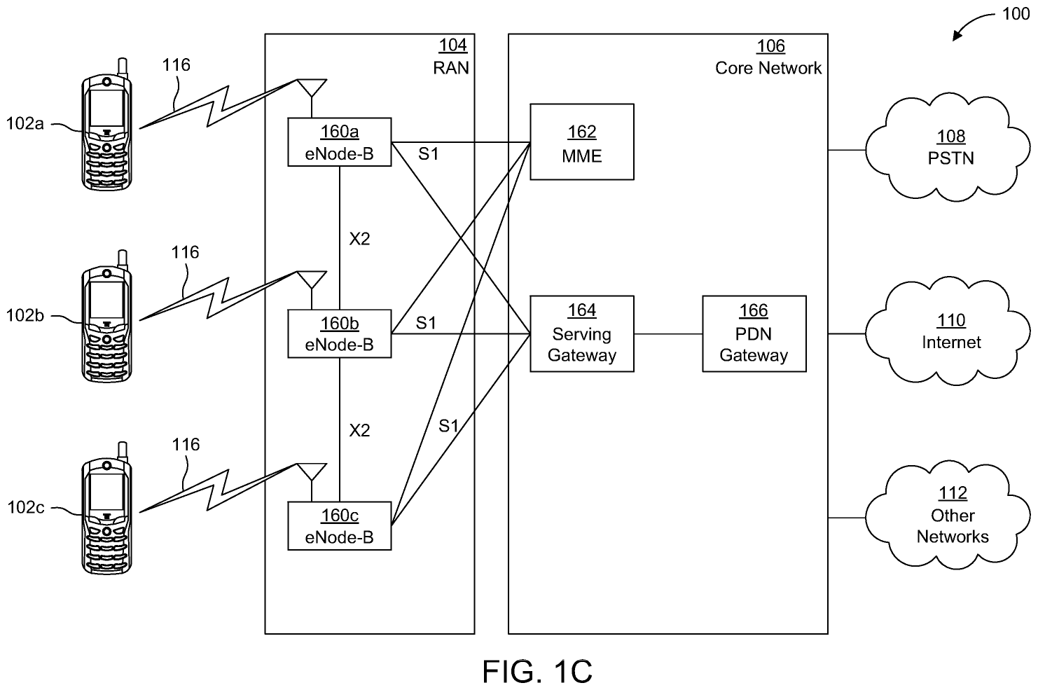

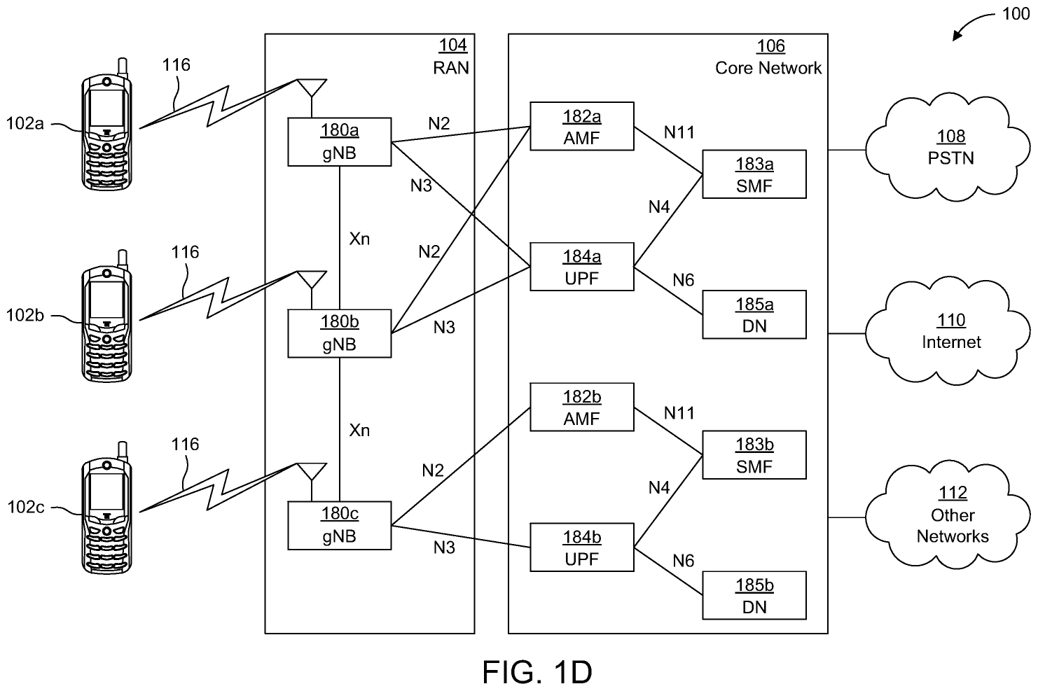

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

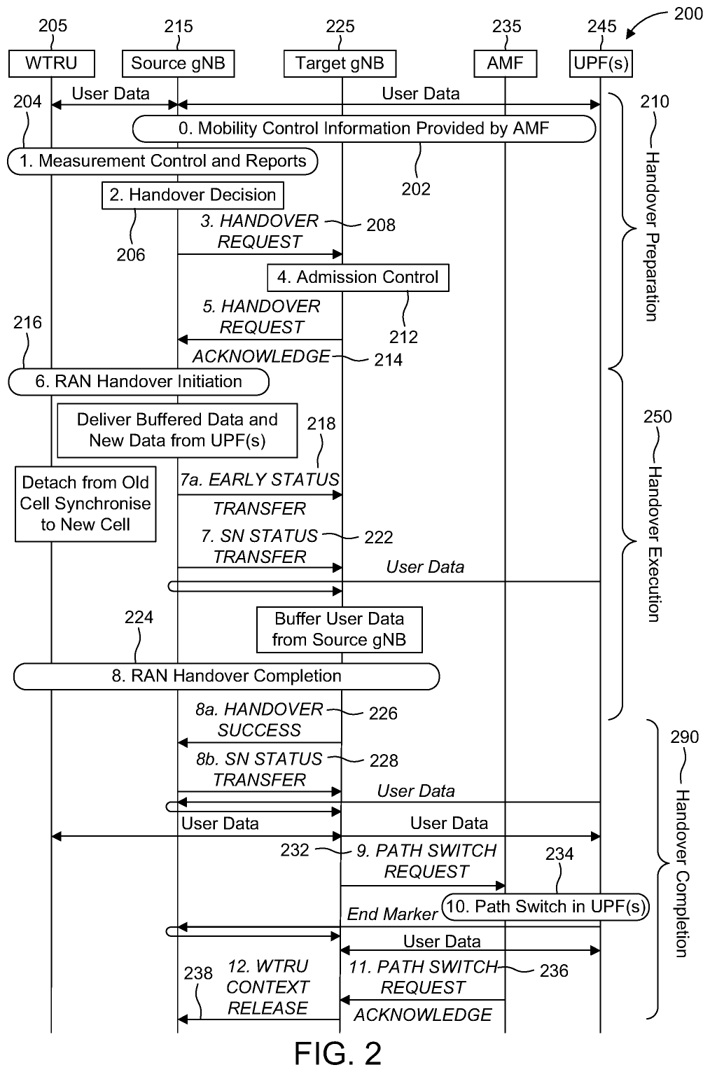

FIG. 2 illustrates a basic handover procedure 200 in NR. In procedure 200, a WTRU 205, base station, such as source gNB 215, a base station, such as target gNB 225, AMF 235 and one or more UPFs 245 are in communication. Procedure 200 includes three main parts including handover preparation 210, handover execution 250, and handover completion 290.

Handover preparation 210 includes mobility control information provided at 202 by AMF 235. The mobility control information may be provided to source gNB 215 and target gNB 225. WTRU 205 connects within source gNB 215 contains information regarding roaming and access restrictions which were provided either at connection establishment or at the last TA (Timing Advance) update.

Measurement and control reports are provided 204 between WTRU 205 and source gNB 215. Source gNB 215 configures WTRU 205 measurement procedures and WTRU 205 reports according to the measurement configuration.

At 206, a handover decision is made. Source gNB 215 decides to handover WTRU, 205 based on the received measurements in 204.

At 208 the handover is requested. Source gNB 215 issues a Handover Request message at 208 to target gNB 225. The handover request message may pass a transparent RRC container with necessary information to prepare the handover at the target side. The necessary information may include at least the target cell ID, KgNB*, the C-RNTI of WTRU 205 in source gNB 215, RRM-configuration including WTRU inactive time, basic AS-configuration including antenna Info and DL Carrier Frequency, the current QoS flow to DRB mapping rules applied to WTRU 205, the SIB1 from source gNB 215, WTRU 205 capabilities for different RATs, PDU session related information, and may include WTRU 205 reported measurement information including beam-related information, if available.

Admission control is provided at 212. Admission Control may be performed by target gNB 225, for example.

The handover request is acknowledged at 214 from target gNB 225 to source gNB 215. If WTRU 205 can be admitted, target gNB 225 prepares the handover with L1/L2 and sends the HANDOVER REQUEST ACKNOWLEDGE 214 to source gNB 215, which includes a transparent container to be sent to WTRU 205 as an RRC message to perform the handover.

Handover execution 250 includes the RAN performing handover initiation at 216. Source gNB 215 may trigger the Uu handover by sending an RRCReconfiguration message to WTRU 205. The RRCReconfiguration message may contain the information required to access the target cell: at least the target cell ID, the new C-RNTI, the target gNB security algorithm identifiers for the selected security algorithms. The RRCReconfiguration message may include a set of dedicated RACH resources, the association between RACH resources and SSB(s), the association between RACH resources and UE-specific CSI-RS configuration(s), common RACH resources, and system information of the target cell, etc. In essence, source gNB 215 delivers buffered data and new data from a first UPF and WTRU 205 detaches from the old cell (source gNB 215) and synchronizes to the new cell (target gNB 225). An early status transfer occurs at 218.

Source gNB 215 sends a SN STATUS TRANSFER message to the target gNB 225 at 222 to convey the uplink PDCP SN receiver status and the downlink PDCP SN transmitter status of DRBs for which PDCP status preservation applies (i.e., for RLC AM).

At 224 the handover is completed and handover completion 290 occurs. WTRU 205 synchronizes to target gNB 225 and completes the RRC handover procedure by sending RRCReconfigurationComplete message to target gNB 225 at 226. A SN STATUS TRANSFER occurs at 228.

Target gNB 225 sends a PATH SWITCH REQUEST message at 232 to AMF 235 to trigger 5GC to switch the DL data path towards target gNB 225 and to establish an NG-C interface instance towards target gNB 225 at 234.

5GC switches the DL data path towards target gNB 225. UPF 245 sends one or more “end marker” packets on the old path to source gNB 215 per PDU session/tunnel and then releases any U-plane/TNL resources towards source gNB 215.

AMF 235 confirms the PATH SWITCH REQUEST message at 232 with the PATH SWITCH REQUEST ACKNOWLEDGE message at 236.

Upon reception of the PATH SWITCH REQUEST ACKNOWLEDGE message from AMF 235, target gNB 225 sends WTRU CONTEXT RELEASE at 238 to inform source gNB 215 about the success of the handover. Source gNB 215 may release radio and C-plane related resources associated to WTRU 205. Any ongoing data forwarding may continue.

Conditional HO and CPC exists in NR. Conditional handover (CHO) and conditional PSCell Addition/Change (CPA/CPC, or collectively referred to as CPAC) is directed to reduce the likelihood of radio link failures (RLF) and handover failures (HOF). Legacy LTE/NR handover is typically triggered by measurement reports, even though there is nothing preventing the network from sending a HO command to WTRU 205 even without receiving a measurement report. For example, WTRU 205 is configured with an A3 event that triggers a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). WTRU 205 monitors the serving and neighbor cells and sends a measurement report when the conditions get fulfilled. When such a report is received, the network (current serving node/cell) prepares the HO command (basically, an RRC Reconfiguration message, with a reconfigurationWithSync) and sends it to WTRU 205. WTRU 205 executes the HO command resulting in WTRU 205 connecting to target gNB 225.

The CHO differs from a legacy handover in two main aspects. First, multiple handover targets are prepared (as compared to only one target in legacy case), and second, WTRU 205 does not immediately execute the CHO as in the case of the legacy handover. Instead, WTRU 205 may be configured with triggering conditions a set of radio conditions, and WTRU 205 may execute the handover towards one of the targets only when/if the triggering conditions are fulfilled.

The CHO command may be sent when the radio conditions towards the current serving cells are still favorable, thereby reducing the two main points of failure in legacy handover, i.e., risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after WTRU 205 has sent the measurement report, but before it has received the HO command).

The triggering conditions for a CHO may be based on the radio quality of the serving cells and neighbor cells like the conditions that are used in legacy NR/LTE to trigger measurement reports. For example, WTRU 205 may be configured with a CHO that has an A3 like triggering conditions and associated HO command. WTRU 205 may monitor the current and serving cells and when the A3 triggering conditions are fulfilled. WTRU 205 may, instead of sending a measurement report, execute the associated HO command and switch its connection towards target gNB 225.

Another benefit of CHO is in helping prevent unnecessary re-establishments in case of a radio link failure. For example, assume the WTRU is configured with multiple CHO targets and the WTRU experiences an RLF before the triggering conditions with any of the targets gets fulfilled. Legacy operation would have resulted in RRC re-establishment procedure that would have incurred considerable interruption time for the bearers of the WTRU. However, in the case of CHO, if the WTRU, after detecting an RLF, ends up a cell for which it has a CHO associated with (i.e., the target cell is already prepared for it), the WTRU may execute the HO command associated with this target cell directly, instead of continuing with the full re-establishment procedure.

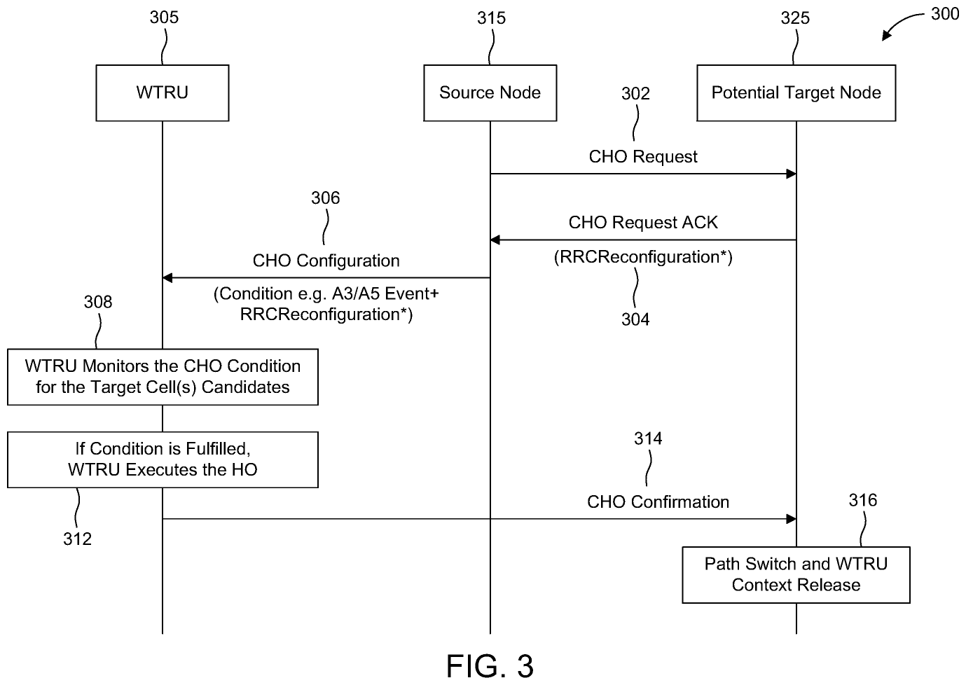

FIG. 3 illustrates a conditional handover configuration and execution 300. Conditional handover configuration and execution 300 includes a WTRU 305, a source node 315, an d a potential target node 325. Source node 315 provide a CHO request to potential target node 325 at 302. Potential target node 325 provides source node 315 with a CHO request ACK at 304. CHO Request ACK may be in the form of a RRCReconfiguration as described herein.

Source node 315 may provide a CHO configuration to WTRU 305 at 306. The CHO configuration may include a condition, such as an A3/A5 event plus a RRCReconfigruation as described herein. WTRU 305 may monitor the CHO condition for the target cell 325 candidate at 308. If the condition is fulfilled WTRU 305 executes the HO at 312. WTRU 305 provides a CHO confirmation at 314 to target node 325. A path switch and WTRU context release may occur at 316 to complete the handover.

CPC and CPA are just extensions of CHO, but in DC scenarios. WTRU 305 may be configured with triggering conditions for PSCell change or addition, and when the triggering conditions are fulfilled, WTRU 305 may execute the associated PSCell change or PSCell add commands.

Radio link monitoring and detection of radio link failure may occur. A WTRU that is in RRC_CONNECTED may continuously monitor the radio link for ensuring the link is good/reliable enough for communication, a process referred to as Radio Link Monitoring (RLM). The WTRU may monitor the downlink (DL) quality based on the reference signal that is being broadcasted from the serving cell. In case the WTRU is in operating in single connectivity, the WTRU may perform RLM on the Primary Cell (PCell). In case the WTRU is operating in dual connectivity (DC), the WTRU may perform RLM on both the PCell and the primary cell of the secondary cell group (SCG), which is referred to as PSCell.

The WTRU may be configured with the RLM reference signals (RLM-RS) to monitor in order to determine the radio quality of the PCell (and the PSCell, in case of DC). The network can configure the WTRU to perform the RLM based on SSB (Synchronization Signal Block), CSI-RS (Channel State Information-Reference Signal), or a combination of the two.

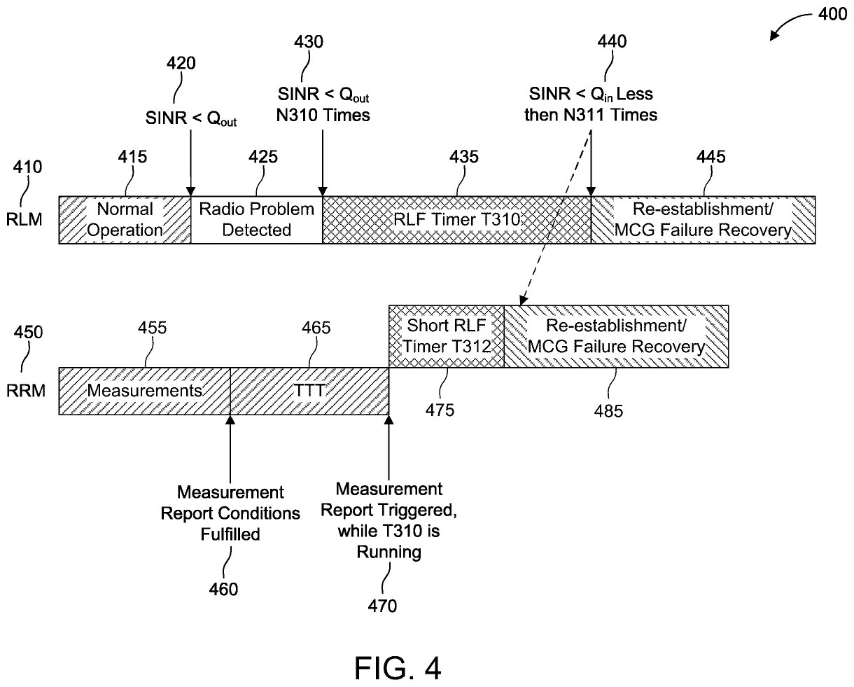

FIG. 4 illustrates the RLM and RLF detection mechanisms 400 described below. WTRUs may be configured with thresholds to determine whether the radio link being monitored is good/reliable enough. Specifically: Qout and Qin. Qout is the level at which the DL cannot be reliably received and shall correspond to out-of-sync block error rate (BLERout) which is the 10% block error rate of a hypothetical PDCCH transmission. Qin is the level at which the DL can be significantly more reliably received than at Qout and shall correspond to in-sync block error rate (BLERin), which is 2% block error rate of a hypothetical PDCCH transmission.

WTRUs may be configured with timers and counters that are used to determine the reliability of the link being monitored, specifically: n310, n311, t310 and t311. n310 refers to the number of consecutive times that an out of sync indication is received at the RRC from the lower layers (e.g., PHY) before RRC starts considering the link being monitored as experiencing reliability problem. n311 refers to the number of consecutive times that an in-sync indication is received at the RRC from the lower layers (e.g., PHY) before RRC considers the link being monitored has become reliable again. t310 refers to the duration of the timer that is started upon n310 consecutive out-of-sync indications received from lowers, and stopped upon n311 consecutive in-sync indications. The timer defines for how long the WTRU should attempt to recover (regain sync) the radio link on the current cell (after out of sync detected). t311 refers to the duration of the timer that is started upon t310 expiry, and stopped when the WTRU selects a suitable cell. The timer defines for how long the WTRU should attempt to search for another cell to re-establish the RRC connection after radio link failure and before declaring RRC connection failure. If the T310 timer expires before the reception of n311 consecutive in-sync indications from lower layers, RRC may consider the link has failed and declare an RLF (Radio Link Failure).

The WTRU may employ another timer (T312) to detect RLF, which is associated with measurement reporting. A measurement reporting configuration may be associated with t312. When the reporting conditions are fulfilled and a measurement report is to be sent, and if this measurement reporting configuration has been associated with t312, the WTRU may check if the t310 is already running (i.e., RLM has already identified a problem and waiting for the recovery). If so, the WTRU starts the T312 timer, with the duration set to the configured t312, and if the problem is not resolved before the timer expires, then the WTRU also declares an RLF. Basically, T312 is used to detect a late HO (i.e., had the measurement reporting been sent earlier than the radio link problem started, the WTRU would probably been handed over to a target cell in time).

Specifically, in FIG. 4, RLM 410 may include a normal operation 415. Normal operation 415 may occur until SINR<Qout, (420) at which point a radio problem is detected at 425. When SINR<Qout N310 times (430) an RLF timer T310 is initiated at 435. When SINR>Qin less than N311 times (440), reestablishment and MCG failure recovery occurs at 445.

In FIG. 4, RRM 450 may include measurements 455 that occur until the measurement report conditions are fulfilled (460). On the measurement report conditions are fulfilled (46) TTT occurs at 465 until measurement report triggered while T310 is running (470). At such a point, a short RLF timer T312 begins at 475. When SINR>Qin less than N311 times (440), reestablishment and MCG failure recovery occurs at 485.

In addition to the described RLM and RLF detection mechanisms, there are other cases where the RRC considers as an RLF. In an example, the RRC considers an RLF upon random access problem indication from MAC (e.g., when a WTRU doesn't receive a random-access response (RAR) after sending a random-access preamble to the network a certain number of times). In an example, the RRC considers an RLF upon indication from RLC that the maximum number of retransmissions has been reached. In an example, the RRC considers an RLF if connected as an Integrated Access Backhaul (IAB)-node, upon Back Haul (BH) RLF indication received on BackHaul Adaptation Protocol (BAP) entity (i.e., the link between the IAB node and the network has failed). In an example, the RRC considers an RLF upon consistent uplink LBT (listen before talk) failure indication from MAC when operating in unlicensed mode:

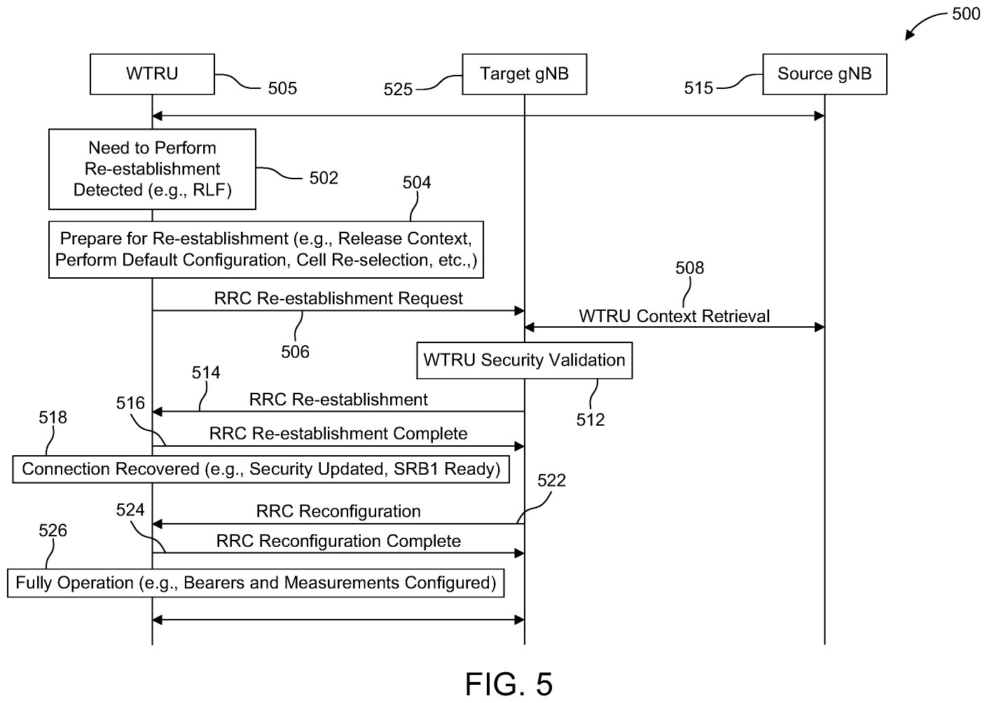

FIG. 5 illustrates a high-level overview of the re-establishment procedure 500. WTRU 505, source gNB 515 and target gNB 525 are included. Upon detecting an RLF, according to any of the causes described above, WTRU 505 may perform an RRC re-establishment to recover the radio link at 502. In addition to RLF, there are also several triggers for WTRU 505 to trigger re-establishment, such as upon re-configuration with sync failure with the target cell during HO, upon HO failure from NR to another RAT, upon integrity check failure for CP data (e.g., data received via SRB1 or SRB2), and upon RRC connection reconfiguration failure (e.g., WTRU unable to compile/execute the received RRC reconfiguration file).

During the re-establishment procedure, WTRU 505 may perform several functions at 504. One function is to reset the MAC. Another function is to release the WTRU configuration/context (including security configuration). WTRU 505 may perform cell re-selection (i.e., select the cell with the best radio quality WTRU 505 can measure at the time). WTRU 505 may apply default configurations and send an RRC Re-establishment request message at 506 to the network. The message may be sent to target gNB 525. This message may include information, such as the identity of WTRU 505 (e.g., C-RNTI) at the source cell where the re-establishment was triggered, the PCI of the source cell, security integrity information that is derived based on the security configuration that was used at the source cell, the cause of the re-establishment (e.g., RLF, integrity verification failure, reconfiguration failure, etc.),

Target gNB 525 may perform WTRU security validation at 512. Target gNB 525 (via the network) may use the security information included in the re-establishment request to verify the request is from a legitimate WTRU and recover the latest WTRU context/configuration using the provided WTRU identity and source cell identity (e.g., if the WTRU is re-establishing at a target cell different from the source cell and the target cell is served by a gNB that is different from the gNB serving the source cell, the target gNB may request the WTRU context/configuration information from the source). Once target gNB 525 performs this security validation at 512, target gNB 525 may send WTRU 505 an RRC Re-establishment message at 514. RRC Re-establishment message may include information for WTRU 505 to update the security context. WTRU 505 may send a RRCReestablishmnet complete message at 516. The connection may be recovered at 518 (e.g., security updated, SRB1 operational, etc.)

SRB1 may be functional and target gNB 525 may send an RRC Reconfiguration message at 522 to WTRU 505 to finalize the recovery (e.g., provide new WTRU identity, setup the bearers, configure measurements, etc.). The configuration of the WTRU identity, the bearers, measurements, etc., may be the same as that was used in the source cell before the re-establishment was triggered or it could be different (e.g., another WTRU at the target is already using the identity, not all the bearers can be admitted at the target, some measurement configuration may have to be modified due to the target's capability/configuration, etc.). Once completed WTRU 505 may be fully operation at 526 with bearers and measurements configured as described.

If WTRU 505 is configured with conditional reconfiguration, WTRU 505 may perform a slightly enhanced re-establishment procedure. WTRU 505 may not release its context/configuration at the start of the re-establishment procedure, but may determine if the cell re-selection procedure results in a selecting a cell that is a CHO target (i.e., WTRU already has a CHO stored for that target and target is already prepared for the UE). If so, there is no need to continue with the re-establishment procedure and WTRU 505 just executes the associated CHO command.

It should be noted that the re-establishment procedure may not succeed for to several reasons. For example, if WTRU 505 was unable to perform cell re-selection within a given time (e.g., timer T311, which is started when WTRU 505 starts the cell re-selection procedure expires before WTRU 505 has found a suitable cell to re-establish to), WTRU 505 was able to find a suitable cell but the cell became not suitable before the re-establishment procedure was completed, or WTRU 505 did not receive the Reestablishment message from the network within a given time after sending the re-establishment request (e.g., timer T301, which is started when WTRU 505 sends the re-establishment request expires before the reception of the reestablishment command from the network). In these cases, WTRU 505 may be forced to go to RRC_IDLE mode and a recovery via connection setup from scratch may be triggered by WTRU 505, which is an even lengthier procedure than the re-establishment as there is no RAN level context fetching and the CN has to be involved in setting up/configuring the bearers. A similar recovery from scratch is performed (this time triggered by the network), if the WTRU context was not retrieved properly upon the reception of the re-establishment request.

As discussed herein, WTRU 505 may be configured with several timer values and counters that are used in the detection and recovery of radio link problems. WTRU 505 may be provided with the timer and counters configuration either in a dedicated (i.e., WTRU specific) or broadcasted manner (i.e., cell specific). The Information Element (IE) RLF-TimersAndConstants may be used to configure WTRU specific timers and constants, and may be included in the main serving cell configuration (for the PCell, and if the WTRU is operating in DC, also for the PSCell). The RLF-TimersAndConstants information element and RLF-TimersAndConstants field descriptions are provided below.

-- ASN1START
-- TAG-RLF-TIMERSANDCONSTANTS-START
RLF-TimersAndConstants ::= SEQUENCE {

| | |
|---|---|
| t310 | ENUMERATED {ms0, ms50, ms100, ms200, ms500, |

ms1000, ms2000, ms4000, ms6000},

| | |
|---|---|
| n310 | ENUMERATED {n1, n2, n3, n4, n6, n8, n10, n20}, |
| n311 | ENUMERATED {n1, n2, n3, n4, n5, n6, n8, n10}, |

```
  ...,
  [[
```

| | |
|---|---|
| t311 | ENUMERATED {ms1000, ms3000, ms5000, ms10000, |

ms15000, ms20000, ms30000}
]]
}
-- TAG-RLF-TIMERSANDCONSTANTS-STOP
-- ASN1STOP

RLF-TimersAndConstants field descriptions

n3xy
Value n1 corresponds to 1, value n2 corresponds to 2 and so on.
t3xy
Value ms0 corresponds to 0 ms, value ms50 corresponds to 50 ms
and so on.

The IE WTRU-TimersAndConstants is included in SIB1 and contains timers and constants that are used by the WTRU In RRC_CONNECTED, RRC_INACTIVE and RRC_IDLE (which contains additional timers that are used for other purposes). The WTRU TimersAndConstants information element is provided below.

-- ASN1START
-- TAG-WTRU-TIMERSANDCONSTANTS-START
WTRU-TimersAndConstants ::= SEQUENCE {

| | |
|---|---|
| t300 | ENUMERATED {ms100, ms200, ms300, ms400, ms600, |

ms1000, ms1500, ms2000},

| | |
|---|---|
| t301 | ENUMERATED {ms100, ms200, ms300, ms400, ms600, |

ms1000, ms1500, ms2000},

| | |
|---|---|
| t310 | ENUMERATED {ms0, ms50, ms100, ms200, ms500, |

ms1000, ms2000},

| | |
|---|---|
| n310 | ENUMERATED {n1, n2, n3, n4, n6, n8, n10, n20}, |
| t311 | ENUMERATED {ms1000, ms3000, ms5000, ms10000, |

ms15000, ms20000, ms30000},

| | |
|---|---|
| n311 | ENUMERATED {n1, n2, n3, n4, n5, n6, n8, n10}, |
| t319 | ENUMERATED {ms100, ms200, ms300, ms400, ms600, |

ms1000, ms1500, ms2000},
...
}
-- TAG-WTRU-TIMERSANDCONSTANTS-STOP
-- ASN1STOP

If WTRU 505 is provided with the rlf-timers-AndConstants, the timers/counters configured therein may override the ones that are broadcasted in SIB1 in the WTRU-TimersAndConstants.

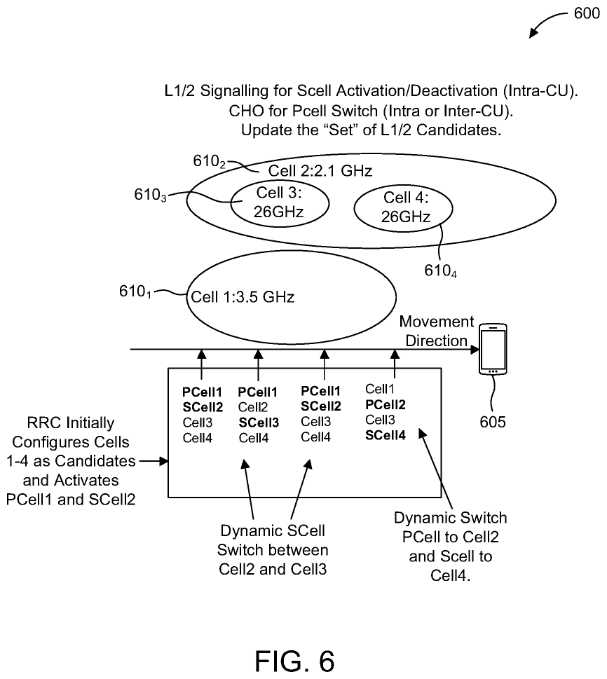

FIG. 6 illustrates an example of L1/2 inter-cell mobility operation, whereby the candidate cell group is configured by RRC and a dynamic switch of PCell and SCell is achieved using L1/2 signaling. Inter-cell L1/2 mobility may be used to manage the beams in CA case, but no cell change/add is supported. The objectives of the WI “Further NR Mobility Enhancements” is to specify a mechanism and procedures of L1/L2 based inter-cell mobility for mobility latency reduction.

To specify mechanism and procedures of L1/L2 based inter-cell mobility for mobility latency reduction: configuration and maintenance for multiple candidate cells to allow fast application of configurations for candidate cells [RAN2, RAN3]; dynamic switch mechanism among candidate serving cells (including SpCell and SCell) for the potential applicable scenarios based on L1/L2 signaling [RAN2, RAN1]; L1 enhancements for inter-cell beam management, including L1 measurement and reporting, and beam indication [RAN1, RAN2], where early RAN2 involvement is necessary, including the possibility of further clarifying the interaction between this bullet with the previous bullet; timing Advance management [RAN1, RAN2]; and CU-DU interface signaling to support L1/L2 mobility, if needed [RAN3]. FR2 specific enhancements are not precluded, if any. The procedure of L1/L2 based inter-cell mobility are applicable to the following scenarios: standalone, CA and NR-DC case with serving cell change within one CG; intra-DU case and intra-CU inter-DU case (applicable for Standalone and CA: no new RAN interfaces are expected); both intra-frequency and inter-frequency; both FR1 and FR2; source and target cells may be synchronized or non-synchronized; and inter-CU case is not included.

L1/L2 based mobility provides and inter-cell beam management addresses intra-DU and intra-frequency scenarios. In this case the serving cell remains unchanged (i.e., there is no possibility to change the serving cell using L1/2 based mobility). In FR2 deployments, CA is typically used in order to exploit the available bandwidth, e.g., to aggregate multiple CCs in one band. These CCs are typically transmitted with the same analog beam pair (gNB beam and WTRU beam). The WTRU is configured with TCI states (can have fairly large number, e.g., 64) for reception of PDCCH and PDSCH. Each TCI state includes a RS or SSB that the WTRU refers to for setting its beam. For R17, the SSB may be associated with a non-serving PCI. MAC signaling (“TCI state indication for WTRU-specific PDCCH MAC CE”) activates the TCI state for a Coreset/PDCCH. Reception of PDCCH from a non-serving cell is supported by MAC CE indicating a TCI state associated to non-serving PCI. MAC signaling (“TCI States Activation/Deactivation for UE-specific PDSCH”) activates a subset of (up to) 8 TCI states for PDSCH reception. DCI indicates which of the 8 TCI states. R17 also supports “unified TCI state” with a different updating mechanism (DCI-based), but without multi-TRP. R18 will support unified TCI state with multi-TRP.

The overall objective of L1/2 inter-cell mobility is to improve handover latency; with a conventional L3 handover or conditional the WTRU may typically first send a measurement report using RRC signaling. In response thereto, the network may provide a further measurement configuration and potentially a conditional handover configuration. With a conventional handover the network provides a configuration for a target cell after the WTRU reports using RRC signaling that the cell meets a configured radio quality criteria. With conditional handover, in order to reduce the handover failure rate due to the delay in sending a measurement report then receiving an RRC reconfiguration the network provides, in advance, a target cell configuration as well as a measurement criteria which determines when the WTRU may trigger the CHO configuration. Both of these L3 methods, however, may suffer from some amount of delay due to the sending of measurement reports and receiving of target configurations, particularly in case of the conventional (non-conditional) handover.

In particular, the aim of L1/2 based inter-cell mobility is to allow a fast application of configurations for candidate cells, including dynamically switching between SCells and switching of the PCell (e.g., switch the roles between SCell and PCell) without performing RRC signaling. The inter-CU case may require relocation of the PDCP anchor. Therefore, an RRC based approach is needed at least to support inter-CU handover. One of the aims of L1/2 may be to allow CA operation to be enabled instantaneously upon serving cell change.

FIG. 6 illustrates the example L1/2 inter-cell mobility 600 using CA. Specifically, in the example L1/2 inter-cell mobility 600 the is a cell 1 610₁ operating at 3.5 GHZ, a cell 2 610₂ operating at 2.1 GHZ, a cell 3 610₃ operating at 26 GHZ, and a cell 4 610₄ operating at 26 GHZ (collectively referred to a cells 610). A WTRU 605 is moving past cells 610. A points during the movement of WTRU 605 a varied L1/2 signaling for Scell activation/deactivation (intra-CU may occur. CHO for Pcell switch (intra or inter-CU) may occur. Updates may be provided for the set of L1/2 candidates.

For example, at a first location of WTRU 605 Pcell 1 610₁ and SCell 2 610₂ may be configured instead of cell 3 610₃ and cell 4 610₄. The RRCE initially configures cells 1-4 as candidates and activates PCell 1 610₁ and SCell 2 610₂. At a second location of WTRU 605, Pcell 1 610₁ and SCell 3 610₃ may be configured instead of cell 2 610₂ and cell 4 610₄. As WTRU 605 moves to a third location, a dynamic SCell switch may occur between Cell 2 610₂ and Cell 3 610₃, leaving connection as Pcell 1 610₁ and SCell 2 610₂ instead of cell 3 610₃ and cell 4 610₄. As WTRU 605 moves to a fourth location, a dynamic switch may occur with PCell switching to cell 2 610₂ and SCell switching to cell 4 610₄.

Network energy consumption may be significant and, in some cases, unnecessary, for example, during quiet hours. The network may turn off small cells and rely on macro-cells for coverage during quiet hours, turn off some sectors or gNBs altogether, reduce the PA power consumption, and/or enable a gNB-side sleep pattern without sacrificing WTRU performance considerably. gNBs combine info including WTRU measurements, WTRU assistance info, interference status, load information, proprietary info to make this decision.

One of the enhancements is the introduction of a NES state (also referred to as network availability state). The WTRU may determine whether it can transmit or receive on certain resources depending on a network availability state, which implies the gNB's power savings status. The availability state may be determined by the WTRU or indicated by the network. An availability state can be, for example, “On”, “off”, “dormant”, “micro sleep”, or “deep sleep”. Such states can be abstracted by NW configuration parameters and/or values. The “Off” availability state may imply that the gNB's baseband hardware is completely turned off. The “sleep” availability state may imply that the gNB wakes up periodically to transmit certain signals (e.g., a presence signal) or receive certain UL signals. In some availability states, some DL o UL resources are not available during certain periods of time, and this enables the network to turn off baseband processing and other activities. Some measurement resources (e.g., SSBs or CSI-RS) may only be made available in certain availability states.

Under certain conditions, the WTRU may further transmit a request to the network (wake-up request) to modify the availability state to a state for which resources that would satisfy WTRU requirements are available. Such wake-up request may include a transmission that may be decodable by a low-complexity receiver at the gNB for which energy consumption requirement is minimal. Herein, wake up request, turn on request, or switch on WTRU assistance information may be used interchangeably. In certain availability states (e.g., “micro sleep” or “deep sleep”), wake up request may be exclusively used and may refer to a physical uplink signal transmitted by the WTRU to request a change of availability state. The physical layer design of a wake-up request signal is detailed. A switch on request may otherwise be a physical layer or an L2 indication from the WTRU to the network, which may be delivered as a MAC CE, UCI, RRC signaling, PUCCH, or RACH indication, and may include switch on WTRU assistance information and/or a positioning report.

The WTRU may determine an availability state from reception of availability state indication from e.g., by L1/L2 signaling, or implicitly determine it form the reception of periodic DL signaling—or lack thereof—. The WTRU may determine if a resource is available for transmission/reception for the determined network availability state if it is applicable in the active availability state.

An availability state may be applicable to at least one resource. An availability state may be applicable to at least one time period such as a time slot or time symbol. An availability state may be applicable to a serving cell, a cell group, a frequency band, a bandwidth part, a range of frequencies within a bandwidth part.

An NES state change indication may indicate the change is imminent/immediate or there could be a timing information (e.g., the NES state will change to the indicated state after a certain time duration or at a specific absolute time).

In NR, a WTRU may be in one of the following three RRC states: RRC_CONNECTED (also referred to as “CONNECTED mode”); RRC_INACTIVE (also referred to as “INACTIVE mode”); and RRC_IDLE (also referred to as “IDLE mode”).

In RRC_CONNECTED, the WTRU is actively connected to the network, with signaling and data radio bearers established (SRB and DRBs), and able to receive Downlink (DL) data from the network in a unicast fashion and also send Uplink (UL) data to the network. The mobility of the WTRU from one cell/node to another is controlled by the network. Network may configure the WTRU to send measurement reports periodically or when certain conditions are fulfilled (e.g., a neighbor cell becomes better than a serving cell by more than a certain threshold) and based on these reports may send the WTRU a handover command to move the WTRU to another cell/node. The network may also configure a conditional handover, CHO, where instead of sending of a measurement report, the WTRU executes a preconfigured handover command when certain conditions are fulfilled. The network may also send the WTRU a HO command without receiving any measurement report (e.g., based on implementation, such as the determination of current location).

Keeping the WTRU in connected mode is power intensive for the WTRU (e.g., the WTRU needs to continuously monitor the PDCCH of the serving cell, e.g., for determining the arrival of DL data, for UL data scheduling, etc.,), and a certain cell/gNB is able to accommodate a certain number of WTRUs in connected mode (e.g., due to resource limitations). As such, when there is no activity in the UL or DL for a certain duration (e.g., based on an inactivity timer kept at the network), the network may send the WTRU to the RRC_INACTIVE or RRC_IDLE state.

If the network expects the WTRU to become active for a long duration, the network may send the WTRU to RRC_IDLE state. While in RRC_IDLE, the WTRU camps at the best cell (the cell with the best signal level at the highest priority RAT and highest priority frequency within that RAT), that will facilitate the WTRU establishing the connection via that cell if a need arises for the WTRU to transition back to the connected state. More details of the cell re-selection procedure that ensures the WTRU is always camping at the best cell is provided herein. The WTRU may monitor the downlink paging channel to detect for DL data arrival. The WTRU may initiate the connection setup/establishment procedure if it detects a paging from the network indicating an arrival of a DL data or if the WTRU needs to send an UL data.

During connection setup or resume, the WTRU may perform a random access (RA) procedure (also referred to as Random Access Channel, RACH, procedure in this disclosure) before sending the RRCSetupRequest or the RRCResumeRequest message. The RA procedure serves two main purposes: get UL synchronization between the WTRU and the network (e.g., gNB); and obtain the resources that are to be used for the sending of the request message.

During the RA procedures, the WTRU may send a message on the RACH (referred to as msg1), that contains a Preamble and an RA-RNTI (Random Access-Radio Network Temporary Identifier) to the gNB. In the case of contention based random access (CBRA), the preamble is randomly selected out of a set of possible preamble values (i.e., there could be a contention if another WTRU initiates a random-access procedure using the same preamble value). In the case of contention free random access (CFRA), a specific preamble is provided to the WTRU beforehand (e.g., when the WTRU was in CONNECTED state, during the transition to the IDLE/INACTIVE state, etc.,). The RA-RNTI is calculated based on the PRACH (physical RACH) occasion at which the random-access message is to be sent to the network.

The gNB, upon receiving msg1, responds with msg2, that contains a Random-Access Response (RAR). In order for the WTRU to get the RAR, the network may send a DCI (Downlink Control Indicator) in the PDCCH that is scrambled with the RA-RNTI, which is used by the WTRU to determine on which resources (i.e., time and frequency) that RAR (and other related info) is provided to the WTRU. The WTRU attempts to detect this DCI within a period of time after sending the preamble (known as the RAR-window). If such DCI is not received, the WTRU may retransmit the preamble again. If the DCI is received, the WTRU may get the RAR at the indicated time and frequency resources in the PDSCH. In the RAR and associated information, the WTRU may be provided with the timing advance (TA) to apply for sending UL data, the TC-RNTI (temporary Cell RNTI), and the UL resources to send the setup/resume request message.

The WTRU may get the detailed information/configuration regarding the usage of the random-access channel, such as RACH occasion, random access response window, etc., via dedicated configuration while in CONNECTED state, upon transitioning during an IDLE/INACTIVE state, or from system information broadcast (SIB).

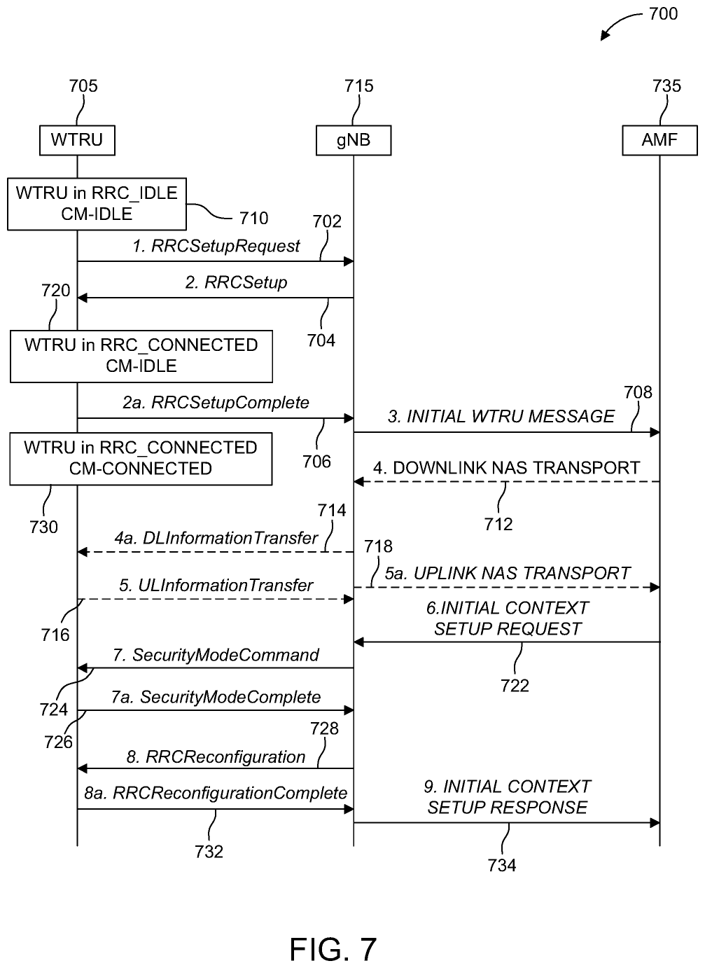

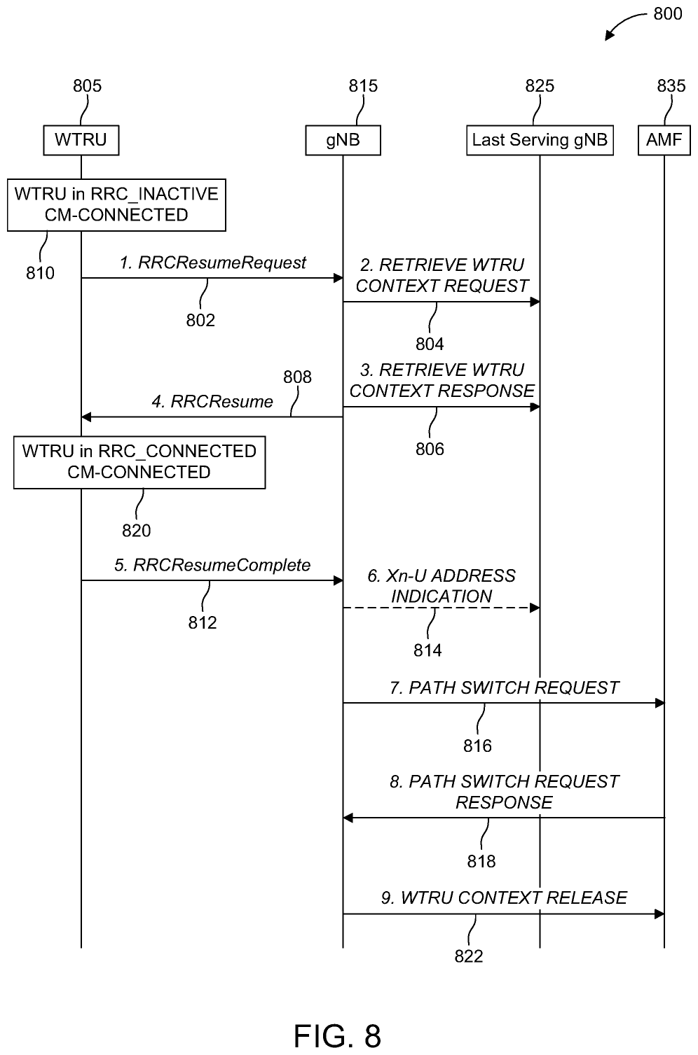

FIGS. 7 and 8 illustrate the RRC connection establishment/setup and connection resume procedures. The RA procedure is not shown in these figures. The term msg3 is used to refer to RRCResumeRequest or RRCSetupRequest. The term msg4 is used to refer to RRCResume or RRCSetup. The term msg5 is used to refer to RRCResumeComplete or RRCSetupComplete. If the WTRU resumes the connection in the same gNB, messages 2, 3, and 6 to 9 may not be required, and as such the WTRU may be resumed without involving the Core Network (CN).

As illustrated in FIGS. 7 and 8 described below, and the above description, the RRC connection setup procedure is a lengthy procedure that requires several round-trip times to complete and involves the CN. This is because when the WTRU goes to IDLE mode, the WTRU's RRC context is released, and as such the WTRU is not known at the RAN level, and the RAN has to get the WTRU context from the CN. Also, security has to be re-established after that and the WTRU reconfigured with the DRBs and SRBs, before UL/DL data transmission/reception could occur.

Such a lengthy setup procedure is not compatible with low latency services and thus NR has introduced an intermediate state between the CONNECTED and IDLE state, known as the INACTIVE state. This state has most of the power saving advantages of the IDLE state (e.g., WTRU does not need to continuously monitor the PDCCH, which is one of the most power consuming procedures in the CONNECTED state), but at the same time, the RAN maintains the WTRU's RRC/Security context. When there is a need to transition the WTRU to CONNECTED mode (e.g., due to the arrival of UL data or the reception of a paging indicating the arrival of DL data), the connection can be resumed very quickly, without involving the CN, re-establishing the WTRU's security context, and reconfiguring the bearers.

FIG. 7 illustrates an example RRC connection setup procedure 700. In procedure 700, a WTRU 705 is communicating via a gNB 715 (also referred to as a base station) and AMF 735. WTRU 705 may be in a RRC_IDLE CM-IDLE mode at 710. WTRU 705 sends a RRCSetupRequest message to gNB 715 at 702. gNB 715 may provide a RRCSetup message to WTRU 705 at 704.

WTRU 705 may be in a RRC-CONNECTED CM-IDLE mode at 720. WTRU 705 may send a RRCSetupComplete message to gNB 715 at 706. gNB 715 may signal AMF 735 with an initial WTRU message at 708. AMF 735 may provide a downlink NAS transport to gNB 715 at 712.

WTRU 705 may be in RRC_CONNECTED CM-CONNECTED state at 730. gNB 715 may signal a DLInformation Transfer to WTRU 705 at 714. WTRU 705 may signal a ULInformationTrasnfer to gNB 715 at 716.

gNB 715 may signal AMF 735 with an uplink NAS transport at 712. AMF 735 may signal an initial context setup request to gNB 715 at 722.

gNB 715 and WTRU 705 signal back and forth regarding security and reconfiguration. For example, gNB 715 signals to WTRU 705 a SecurityModeCommand at 724. WTRU 705 signals to gNB 715 that SecurityModeComlete at 726. gNB 715 signals to WTRU 705 a RRCReconfiguration at 728. WTRU 705 signals to gNB 715 that RRCReconfigurationComplete at 732

FIG. 8 illustrates an example RRC connection setup procedure 800. In procedure 800, a WTRU 805 is communicating via a gNB 815 (also referred to as a base station), a last serving gNB 825 and AMF 835. WTRU 805 may be in a RRC_INACTIVE CM-CONNECTED mode at 810. WTRU 805 sends a RRCResumeRequest message to gNB 815 at 802.

gNB 815 signals the last serving gNB 825 to retrieve WTRU context request at 804. The last serving gNB 825 may signal gNB 815 the retrieve WTRU context response at 806. gNB 815 provides a RRCResume message to WTRU 805 at 808. WTRU 805 enters RRC-CONNECTED CM-CONNECTED state 820.

WTRU 805 sends a RRCResumeComplete message to gNB 815 at 812. gNB 815 provides the Xn-U address indication message to the last serving gNB 825 at 814. Gnb 815 signals AMF 835 a path switch request at 816. AMF 835 provides a path switch request response to gNB 815 at 818. gNB 815 provides the last serving gNB 825 a WTRU context release message at 822.

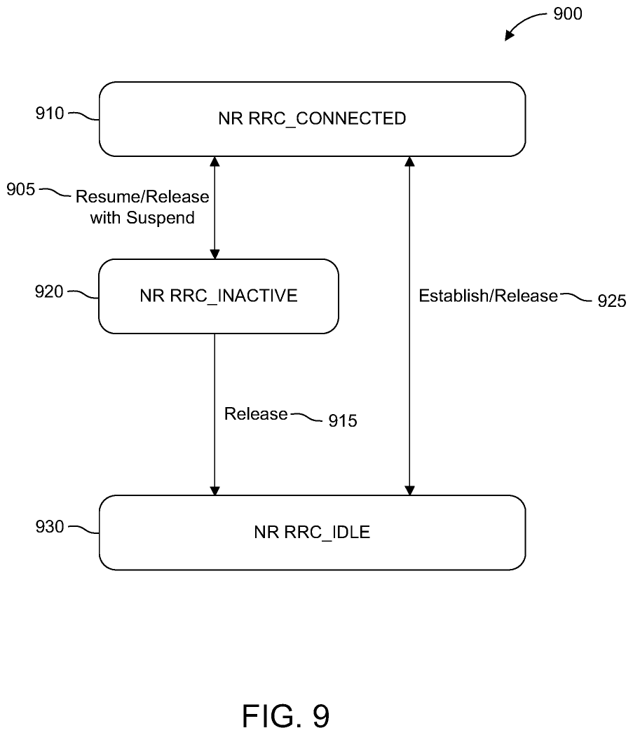

FIG. 9 illustrates the different RRC states and the transitions that may occur in depiction 900. One state is NR RRC_CONNECTED state 910. From RRC-CONNECTED state 910, a resume/release with suspend transition 905 may occur to enter the NR RRC_INACTIVE state 920. A resume/release with suspend transition 905 may operate to transition from RRC-INACTIVE state 920 to RRC-CONNECTED state 910.

From RRC-INACTIVE state 920, a release transition 915 may occur to enter NR RRC-IDLE state 930.

From RRC-CONNECTED state 910, an establishment/release transition 925 may occur to move to the RRC_IDLE state 930. The establishment/release transition 925 may operate to transition from RRC_IDLE state 930 to RRC-CONNECTED state 910.

When the WTRU performs the connection setup/establishment or resume procedure, it includes (in the RRCSetupRequest or RRCResumeRequest), the establishment or resume cause. Currently, the following causes are defined.

```
EstablishmentCause ::= ENUMERATED {
      emergency, highPriorityAccess, mt-Access, mo-Signalling,
            mo-Data, mo-VoiceCall, mo-VideoCall, mo-SMS,
            mps-PriorityAccess, mcs-PriorityAccess,spare6,
spare5, spare4, spare3, spare2, spare1}
ResumeCause ::= ENUMERATED {emergency, highPriorityAccess,
mt-Access, mo-Signalling,
    mo-Data, mo-VoiceCall, mo-VideoCall, mo-SMS, rna-
Update, mps-
PriorityAccess,mcs-PriorityAccess,
  spare1, spare2, spare3, spare4, spare5 }
```

For example, if the connection is being setup/resume due to a voice call or video call originating from the WTRU, the WTRU may set the establishment/resume cause to mo-VoiceCall (mobile originated voice call) or mo-VideoCall (mobile originated video call). As another example, if the connection is being setup/resumed due to downlink paging indicating DL data, the WTRU may set the establishment/resume cause to one of mt-Access (mobile terminated access), highPriorityAccess, mps-PriorityAccess, or mcs-PriorityAccess (depending on the access category of the WTRU).

When the WTRU is sent to INACTIVE state 920, the network may include in the RRCRelease message a suspendConfig. The SuspendConfig contains information described below. The information may include the resumeIdentity to be used by the WTRU (a short identity, shortl-RNTI, and a long identity, full-RNTI). The WTRU may determine which identity to use based on the system information broadcast in the target cell (e.g., if useFullResumeID is indicated in the SIB, use the long identity, otherwise, use the short identity). The information may include the RAN paging area (e.g., list of cells), which is the RAN area where the WTRU can be paged at RAN level. If the WTRU performs cell re-selection to a cell outside the RAN area, WTRU performs RAN area update procedure. The information may include the nextHopChaining count, which is used for deriving the security context (e.g., encryption/integrity protection keys) upon resuming the connection.

As described herein, NES via power level control of the serving cell or even turning it off. However, this may have repercussions on WTRU performance. For example, if a cell is turned off, a multitude of WTRUs may detect RLF and initiate RRC re-establishment. Such a behavior is highly undesirable from both the WTRUs and the network perspective. For the WTRU, re-establishment may cause a considerable service interruption because most of the WTRU context is released, the PDCP/RLC is re-established, MAC is reset, etc. For the network, re-establishment, especially when several WTRUs trigger it, may cause high signaling overhead (both at the air interface for full reconfiguration, and possible X2 interactions between source and target, if the WTRU context is to be fetched in order to avoid involving CN). Also, when several WTRUs attempt re-establishment at the same time, RACH collisions during initial access attempt at the target cell(s) by multiple WTRUs at once may further delay the re-establishment and exacerbate the service interruption.

In the context of L1/L2 mobility, a WTRU may be configured with several candidate cells, some of them belonging to the same CU, even to the same DU, where the WTRU can be easily handed over to using L1/L2 signaling. If a WTRU experiences an RLF, it may be overkill to perform a re-establishment and cause service interruption while there is a cell that the WTRU could easily be handed over to. As discussed herein, the CHO remedies some issues (e.g., if the WTRU, after RLF, selects a cell that is already configured for CHO execute the CHO rather than perform a re-establishment). However, CHO will require resource reservation at target cells/nodes. Specially, in scenarios like network energy saving, enabling the turning off a cell without causing re-establishment for a multitude of WTRUs by configuring a CHO may not be feasible (e.g., not enough resources can be allocated/reserved for CHO without impact WTRUs in the target cells).

Another scenario that is similar to the NES one is the integrated access and backhaul (IAB) or the U2N SL-relay case where a multitude of WTRUs may be served via a single IAB node or SL relay WTRU. If the backhaul link between the IAB node or relay WTRU and the gNB fails, the WTRUs that are being served by the IAB node or relay WTRU may trigger re-establishment and experience considerable service degradation and also cause massive network signaling overhead.

Re-establishments, especially in scenarios where several WTRUs trigger re-establishment at the same time is highly undesirable both from the WTRUs and network perspective. In one solution, a WTRU in RRC_CONNECTED may be configured to trigger an RRC Connection Resume procedure when one or more triggering conditions are fulfilled, for example: detection of an RLF; on serving and/or neighbor cell fulfilling an absolute or/and relative threshold of serving and/or neighbor cell; on the reception of a L1/L2 mobility indication; the WTRU has not transmitted a previous resume request with the same MAC-I, I-RNTI or C-RNTI, possibly to the same network node receiving it (e.g., to prevent a replay attack); on detecting that the serving cell has changed or is going to change its NES state, etc. The WTRU may be configured with a subset of NES state, upon determining that the serving cell has changed to one of those, the WTRU may consider this condition to be met.

In one solution, a WTRU in RRC_CONNECTED state 910 may be configured to trigger an RRC Connection Resume procedure on (or for) a different cell (e.g., an equivalent cell) upon or after detecting a BFD on a serving cell (e.g., SpCell), possibly conditioned on at least one of the following: measuring at least one beam with measured channel conditions above a threshold (e.g., Qin), measuring an L3 channel measurement above a threshold and/or higher than that of the serving cell, not measuring any beam (including CSI-RS and SSBs) on the serving cell (e.g., SpCell) with a channel measurement above a threshold, having at least a minimum number of beams on the neighboring cell measured with a quality above a threshold, not succeeding a BFR or BFR-RA on the serving cell, and/or the BFR timer on the SpCell has expired.

In one solution, the WTRU may be configured with a resume identity to use during the RRC Connection resume that is initiated based on any of the triggering conditions discussed above.

In one solution, the WTRU may be configured with a security related configuration (e.g., nextHopChaining count) that is used to derive the security context during the resume procedure.

In one solution, the WTRU may be configured with a list of alternate/equivalent cells towards which it can perform the RRC Connection Resume while in RRC_CONNECTED. For example, this could be a list of cell identities (e.g., PCIs, CGIs, Tracking areas etc.,).

The alternate or equivalent cell list can contain one or more of the following: the candidate cells configured for L1/L2 mobility; cells configured for CA (e.g., SCells); cells configured for DC (e.g., PSCell, SCG SCells, etc.,); and cells that are not serving cells or mobility candidate cells.

In one solution, the list of alternate cells may be provided explicitly provided, for example, via system information, and/or via RRC signaling (e.g., within a previous RRC Release and/or release with suspend indication). In another example, the list of cell IDs may be provided via a MAC CE. The MAC CE may indicate identifying information for one or more alternate cells, and a flag to indicate whether one or more cells is activated or deactivated. Alternatively, the WTRU may receive two MAC CEs, one of which is used to activate a list of cells, and another used to deactivate a list of cells.

In one solution, the alternate cells are implicitly determined by the WTRU as the cells that belong to the same DU or CU. The WTRU may be able to determine from the PCIs, PCI ranges, reading the CGIs, etc. Alternatively, the WTRU may be configured with all the cells that belong to the same CU and/or DU, and may consider them as alternate cells.

In one solution, the list of alternate/equivalent cells may be dependent on the current PCell. For example, the WTRU may receive a configuration like: {[PCell=cell x, alternate cells=cell a, b, c], [PCell=cell x, alternate cells=cell a, b, c], etc.}.

In one solution, the WTRU may be configured to trigger the RRC Resume towards a given cell only if that cell is configured as an alternate/available cell and it is the best cell (e.g., highest RSRP) that the WTRU can detect.

In one solution, the WTRU may be configured to trigger the RRC Resume towards a given cell only if that cell is configured as an alternate/equivalent cell and it has a signal level above a certain threshold. If there are several such cells that fulfill this condition, the WTRU may be configured to select the best cell among them.

In one solution, a WTRU may consider one or more previously indicated cells as valid for RRC Resume subject to one or more conditions. For example, a WTRU may consider one or more indicated cells as valid for resume for a certain duration after indication (e.g., the WTRU may start a timer upon indication of one or more cells, upon expiry of which the WTRU no longer considers the cell as valid). In another solutions, once a WTRU has triggered and RRC Resume, a WTRU may discard one or more previously indicated cells as valid.

In one solution, the WTRU may be configured to prioritize cells that are also candidate cells for L1/L2 mobility as compared to cells that are not during the RRC Resume procedure. For example, the WTRU may be configured to apply some positive offset to the measurements of the candidate cells as compared to non-candidate neighbor cells when deciding towards which cell the WTRU may initiate the RRC resume.

In one solution, the WTRU may be configured to prioritize cells that are also serving cells (e.g., SCells, PSCell, SCG SCells, etc.) as compared to cells that are not serving cells during the RRC Resume procedure. For example, the WTRU may be configured to apply some positive offset to the measurements of the serving cells as compared to non-candidate neighbor cells when deciding towards which cell the WTRU may initiate the RRC resume to.

In one solution, the WTRU may be configured to trigger the RRC Resume towards a cell immediately about the determination of the fulfillment of the triggering conditions for the resume.

In one solution, the WTRU may be configured to trigger the RRC Resume towards a cell a certain time after the determination of the fulfillment of the triggering conditions for the resume. For example, if the triggering condition was NES state change and that NES state change is indicated/expected to happen after xms, the WTRU may wait for a certain time (e.g., a random time between 0 and xms) before triggering the RRC Resume This may aid in preventing a storm of RA requests to a given candidate cell at the same time.

In one solution, the WTRU may be configured to include a resume cause value that indicates which of the triggering conditions led to the start of the resume procedure (e.g., RLF, NES state change, etc.).

In one solution, the WTRU may be configured to send latest measurement results to the target during the resume procedure (e.g., in the RRC Resume Complete message). The WTRU may be configured to include the measurement results all the time, or only if the cell to which it is resuming to was not the best cell (e.g., there was a cell that was not configured to be an alternative cell for resuming that has better signal levels). This may help, for example, for the network to handover the WTRU immediately to that cell (e.g., if the difference between the signal level the WTRU is experiencing at the current serving cell and the best cell that was not selected is considerable, indicating that leaving the WTRU connected to the current serving cell may cause too much interference in the network and may limit the performance that the WTRU may be able to get).

In one solution, the WTRU may receive, in the RRC Resume command, information that is to be used for a subsequent RRC Resume while in CONNECTED state. This may be information such as resume identity, next hop chaining count, alternate cells, triggering conditions for the RRC Resume, etc. The alternate cell and the triggering conditions may be provided in a delta or full configuration fashion (if no such information is received, WTRU may keep using the same configuration as before).

In one solution, the WTRU may attempt to re-establish/recover on any of the serving cell and configured equivalent cells while T310 is running, e.g., after detecting N310 out of sync indications but before T310 expires triggering RLF. When T310 expires the WTRU may attempt to search and re-establish on any cell (including non-serving and nonequivalent cells). In other words, the WTRU may attempt to re-establish on any equivalent cell, not only the serving cell, before RLF is declared.

In one solution, the WTRU may attempt re-establishment on equivalent cells after T310 expires (RLF), but before T311 (re-establishment) is started. An additional timer may be used to determine then duration the WTRU may attempt to re-establish on the configured equivalent cells before starting T311 and attempting to re-establish on any cell.

To prevent replay attacks, the WTRU may reuse of resumeMAC-I if the reception entity has not received it yet. Alternatively, the WTRU may transmit another resume request with differentiated input parameters for calculating resumeMAC-I, including a changed: security KEY, PDCP COUNT, MESSAGE, DIRECTION, and/or BEARER. A change in any input parameter may be sufficient for producing a different resumeMAC-I to avoid a replay attack.

To avoid premature resumption at a different cell, a WTRU in RRC_CONNECTED may be configured to trigger an RRC Connection Resume procedure on (or for) a different cell (e.g., an equivalent cell) conditioned on at least one of the serving cell transitioning to an NES state whereby the DTX cycle is larger than a configured threshold. The WTRU may be conditioned on measurements from the serving cell keeps deteriorating.

The WTRU may start a timer-prior to transmitting a resume request-upon satisfying any of the conditions above for transmitting a resume. While the timer is running, the WTRU may measure CSI-RS and/or SSBs on the serving cell. If the change in measured SSBs and/or CSI-RS (e.g., L3 or L1 RSRP, BLER, and/or SINR) has reduced more than a predefined or configured margin, the WTRU may consider this condition to be met.

The WTRU may be conditioned on measurements from the cell on which the resume request is to be transmitted keeps improving. The WTRU may start a timer-prior to transmitting a resume request-upon satisfying any of the conditions above for transmitting a resume. While the timer is running, the WTRU may measure CSI-RS and/or SSBs on the target cell. If the change in measured SSBs and/or CSI-RS (e.g., L3 or L1 RSRP, BLER, and/or SINR) has improved more than a predefined or configured margin, the WTRU may consider this condition to be met.

The WTRU may be conditioned on the expiry of a timer, e.g., an NES state change related timer (e.g., a timer related to signal when the cell sleeps/turns off) or a mobility related timer.

The WTRU may be conditioned on Not receiving a response to a wake-up signal transmitted by the WTRU from the serving cell.

The WTRU may be conditioned on triggering an A3 or A5 event.

The WTRU may be conditioned on having a channel measurement from the serving cell below a threshold (e.g., L1 or L3, SS-RSRP).

The WTRU may be conditioned on having a channel measurement from the target cell above a threshold (e.g., L1 or L3, SS-RSRP).

The WTRU can be configured to transmit RRC Connection Resume message for at least one target cell using procedures and configuration similar to small data transmission in RRC_INACTIVE state, even if the WTRU is in RRC_CONNECTED state. This may enable the WTRU to transmit the message with lower latency and possibly without performing RACH procedure. The WTRU may receive at least the following configuration for each cell on which RRC Connection Resume may potentially take place including uplink bandwidth part including PUSCH configuration information, configured grant information including retransmission timer, association information between SSB indexes and valid PUSCH occasions (SSB-Subset, SSB-PerCG-PUSCH); power control information (PO, alpha), DMRS information, downlink bandwidth part including PDCCH information such as at least one of coreset and search space, CG-SDT-specific configuration such as time alignment timer, timing advance validation information, RSRP threshold for SSB selection, CS-RNTI, logical channel restriction information, e.g., only SRB used for transmission of RRC Connection Resume may be allowed, data volume threshold, RSRP threshold for determination of SDT procedure, RSRP threshold for selection between normal uplink carrier and supplementary uplink carrier, and parameters for random-access based PUSCH transmission such as a number of preambles per SSB per shared random-access occasion for msg3 or msgA transmission, a PRACH mask index, and a search space. At least one of the above resources can be configured using same structure as small data transmission information elements such as sdt-MAC-PHY-CG-Config and SDT-ConfigCommonSIB, for each target cell on which RRC connection resume may take place.

The WTRU may perform transmit the message using procedure based on configured grant-based procedure (CG-SDT) or random-access-based procedure (RA-SDT) for small data transmission. However, the WTRU may utilize information specific to each target cell on which RRC connection resume may take place (instead of information for the serving cell) at least for the following parameters: SSB information (ssb-PositionsInBurst); UL/DL slot configuration (tdd-UL-DL-ConfigurationCommon); PRACH configuration; and Physical cell identity (PCI).

The WTRU may receive at least part of above configuration by dedicated RRC signaling for each target cell, and/or by system information of respective target cell. The WTRU may acquire system information at the target cell prior to transmitting a resume request in it, including sdt-MAC-PHY-CG-Config. The WTRU may avoid transmitting a resume request if the target cell is not configured with RA-SDT and/or CG-SDT resources.

To differentiate a resume request transmitted at the target cell from a resume request for SDT, the WTRU may alter or change the resume cause associated with the RRC resume request message. The UE may be defined with a separate cause (e.g. mobility or handover) to use when the RRC resume is transmitted at a different cell. The UE may perform such resume cause change only if an SDT resource is used to transmit the RRC resume message.

Transmission using a configured grant may take place under a condition that RSRP of the target cell is higher than a configured threshold (e.g., the SDT-rsrp threshold, the CG-rsrp threshold, or a different threshold configured for this purpose).

The WTRU may fall back to RACH procedure and/or fall back to the source cell after initiating CG-SDT procedure in the target cell at least in the following cases: the WTRU does not get receive PDCCH following transmission of PUSCH in the target cell, the WTRU does not receive a DL assignment or a PDSCH transmission (e.g. a DL SDT TB) following the transmission of PUSCH at the target cell, and/or the WTRU determines a NACK for the transmitted payload on PUSCH (e.g. by received an explicit NACK signal and/or by expiry of a timer, such as the SDT CG timer, the SDT CG retransmission timer, the CG timer, or T319a).

The WTRU may start a timer upon transmission of the RRC Resume request message. Upon expiry of the timer, the WTRU may fall back to RACH procedure. Upon falling back to RACH, the WTRU may prioritize the selection of RA-SDT PRACH resources, if configured. Alternatively or additionally, the WTRU may prioritize the selection of non-SDT RA resources.

In one method, the WTRU may transmit an RRC resume request at the target cell upon receiving an RRC release from the source or target cell. The release message may indicate to the WTRU whether to use SDT resource or not, the target cell index on which to the WTRU may transmit the resume request, and/or other related transmission configurations contained in an RRC release message for SDT. In the absence of an RRC release message, the WTRU may reuse stored configurations for SDT used when the WTRU last received an RRC message. The WTRU may include it's C-RNTI part of an SDT payload with an RRC resume initiated by handover.

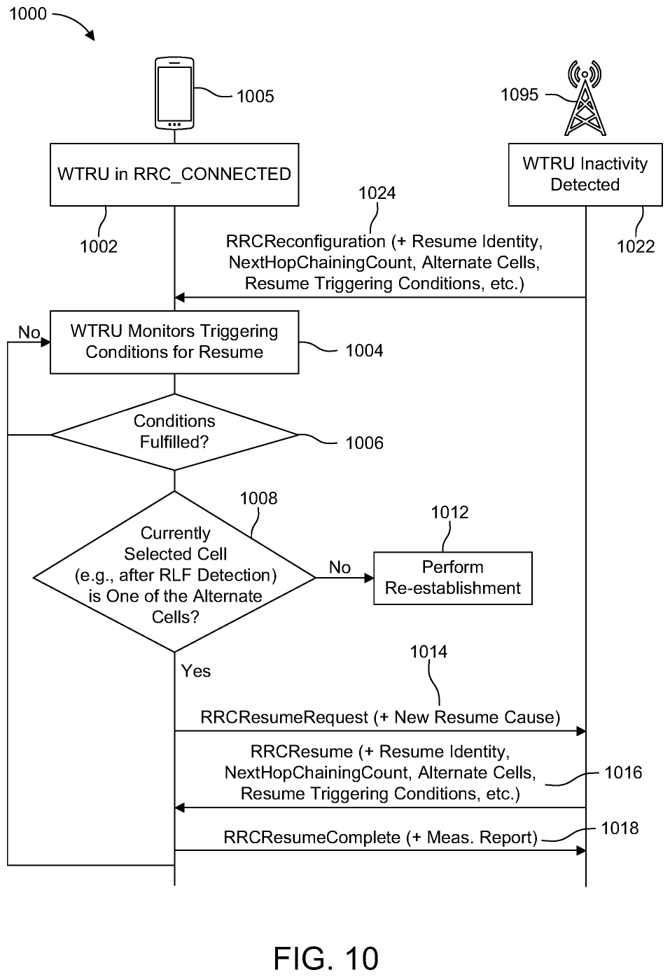

FIG. 10 illustrates a signaling diagram 1000 of a WTRU 1005 in CONNECTED state 1002 configured to perform RRC Resume procedure (e.g., provided with resume identity, next hop chaining count, etc.), upon detecting the fulfilment of triggering conditions, such as RLF. The resume identity, chaining count, etc., are configurations regarding the information the WTRU includes in the resume request. WTRU 1005 monitors the triggering conditions for resume at 1004. As discussed herein, the triggering condition can be one or more of the reception of a L1/L2 mobility indication, the detection of an RLF, the serving and/or neighbor cell fulfilling an absolute or/and relative threshold of serving and/or neighbor cell, the WTRU having not transmitted a previous resume request with the same MAC-I, I-RNTI or C-RNTI, possibly to the same network node receiving it (e.g., to prevent a replay attack), the detecting that the serving cell has changed or is going to change its NES state, for example, the WTRU may be configured with a subset of NES state, upon determining that the serving cell has changed to one of those, the WTRU may consider this condition to be met.

A determination is made on whether the conditions are fulfilled at 1006. If the conditions are determined to be not fulfilled, the WTRU continues monitoring the triggering conditions for resume at 1004. If the conditions are determined to be fulfilled, it is determined whether the currently selected cell (e.g., after RLF detection) is one of the alternate cells at 1008. If the determination is that the currently selected cell is not one of the alternate cells, a reestablishment may be performed at 1012. If the determination is that the currently selected cell is one of the alternate cells, a RRCResumeRequest (plus a new resume cause) is provided from the WTRU 1005 to the network 1095 at 1014. At 1016, the RRCResume (plus any additional information needed for the connection such as resume identity, next hop chaining count, alternate cells, resume triggering conditions, etc.) is provided by the network 1095 to WTRU 1005. WTRU 1005 provides a RRCResumeComplete (plus a measurement report) to the network 1095 at 1018.

If the network 1095 detects inactivity of WTRU 1005 at 1022, a RRCReconfiguration message is provided to WTRU at 1024. Such a message may contain resume identity, nexthopchanining count, alternate cells, resume triggering conditions, for example.

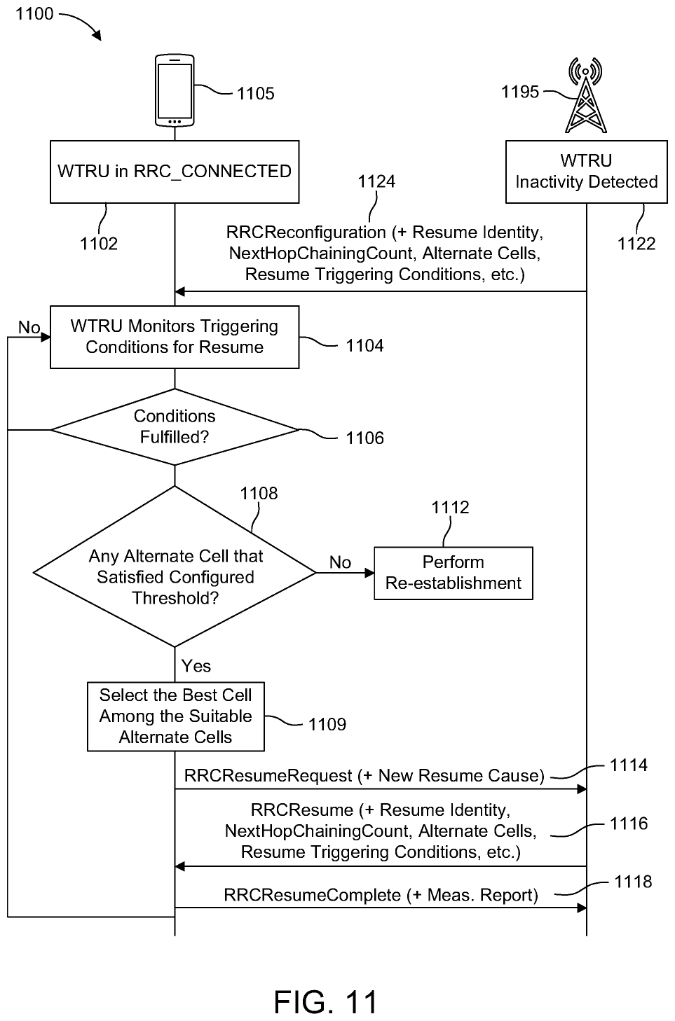

FIG. 11 illustrates a signaling diagram 1100 of a WTRU 1105 in CONNECTED state 1102 configured to perform RRC Resume procedure (e.g., provided with resume identity, next hop chaining count, etc.), upon detecting the fulfilment of triggering conditions, such as RLF. WTRU 1105 monitors the triggering conditions for resume at 1104.

A determination is made on whether the conditions are fulfilled at 1106. If the conditions are determined to be not fulfilled, the WTRU continues monitoring the triggering conditions for resume at 1104. If the conditions are determined to be fulfilled, it is determined whether any alternate cell that satisfies the configured threshold exists at 1108. If the determination is that there are not alternate cells that satisfy the configured threshold, a reestablishment may be performed at 1112. If the determination is that there are alternate cells that satisfy the configured threshold, the best cell among the suitable alternate cells is selected at 1109. In an example, the best cell may be the cell that has the best radio signal level among the candidate cells that fulfilled the conditions.

Once the best cell is selected from the suitable cells at 1109, a RRCResumeRequest (plus a new resume cause) is provided from the WTRU 1105 to the network 1195 at 1114. At 1116, the RRCResume (plus any additional information needed for the connection such as resume identity, next hop chaining count, alternate cells, resume triggering conditions, etc.) is provided by the network 1195 to WTRU 1105. WTRU 1105 provides a RRCResumeComplete (plus a measurement report) to the network 1195 at 1118.

If the network 1195 detects inactivity of WTRU 1105 at 1122, a RRCReconfiguration message is provided to WTRU at 1124. Such a message may contain resume identity, nexthopchanining count, alternate cells, resume triggering conditions, for example.

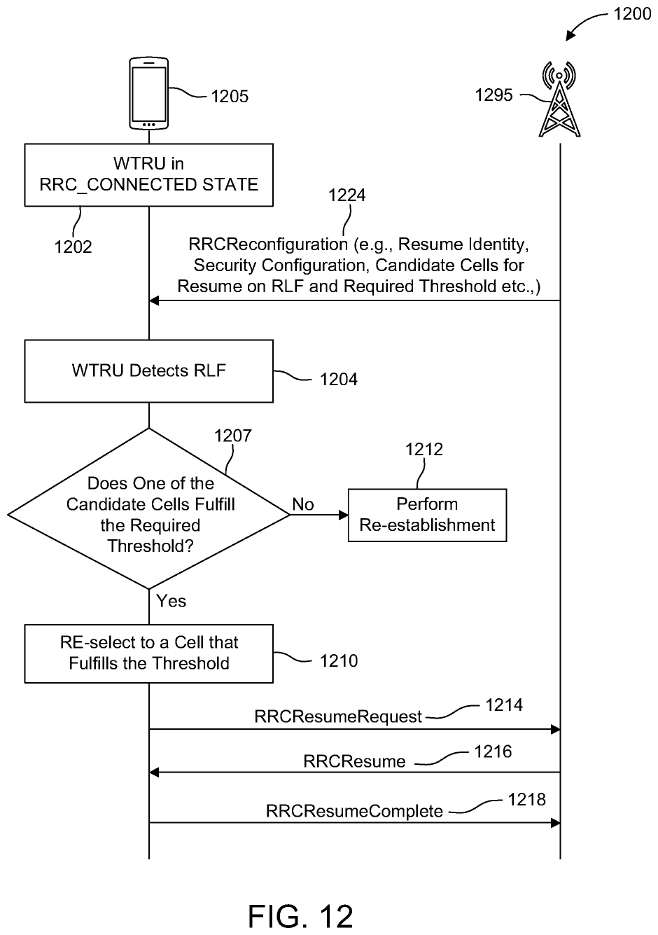

FIG. 12 illustrates a signaling diagram 1200 of a WTRU 1205 in CONNECTED state 1202 configured to perform RRC Resume procedure (e.g., provided with resume identity, next hop chaining count, etc.), upon detecting the fulfilment of triggering conditions, such as RLF. WTRU 1205 detects a RLF at 1204. WTRU 1205 determines if one of the candidate cells fulfills the required thresholds at 1207. If the determination is that the one of the candidate cells does not fulfill the required thresholds, a reestablishment is performed at 1212.

If the determination is that one of the candidate cells does fulfill the required thresholds, reselection may occur for a cell that fulfills the threshold at 1210. A RRCResumeRequest is provided from the WTRU 1205 to the network 1295 at 1214. At 1216, the RRCResume is provided by the network 1295 to WTRU 1205. WTRU 1205 provides a RRCResumeComplete to the network 1295 at 1218.

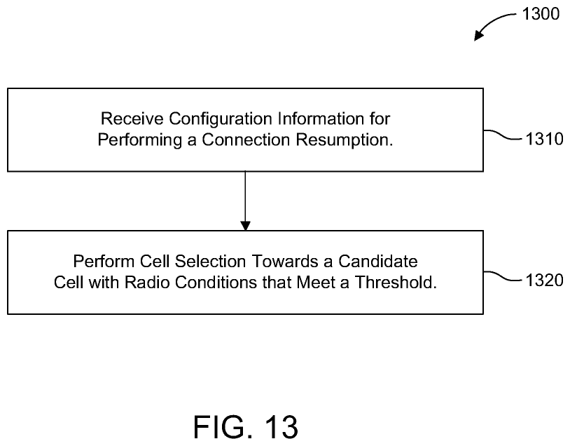

FIG. 13 illustrates a method 1300 for performing RRC Resume procedure according to an aspect. Method 1300 includes receiving configuration information for performing a connection resumption at 1310. The configuration information may at least include a list of candidate cells and an acceptable threshold signal level for a cell to be used The receiving may be in the CONNECTED state

At 1320, method 1300 includes performing cell selection towards a candidate cell with radio conditions that meet a threshold. The cell selection may occur upon detection of an RLF, for example. The candidate cells may be included in the list of candidate cells with radio conditions that meet the threshold by initiating a connection resumption procedure.

Method 1300 may include one or more of WTRU identity to be used during the connection resumption procedure and a security configuration to be applied during the connection resumption procedure. Method 1300 may include performing a re-establishment procedure if there are no cells included in the list of candidate cells that meet the threshold. Method 1300 may include determining the radio conditions of one of the candidate cells from the list of candidate cells meets the threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed in a wireless transmit receive unit (WTRU), the method comprising:
receiving configuration information for performing a connection resumption upon detection of a radio link failure (RLF), the configuration information including one or more of WTRU identity to be used during a connection resumption procedure, a security configuration to be applied during the connection resumption procedure or at least a list of candidate cells, and an acceptable threshold signal level for a cell to be used;
performing, upon detection of an RLF, cell selection towards one of the candidate cells included in the list of candidate cells with radio conditions that meet the acceptable threshold signal level; and
sending a connection resume request message to a network.

2. The method of claim 1 wherein the receiving is in CONNECTED state.

3. The method of claim 1 further comprising receiving subsequent resume parameters of a subsequent resume.

4. The method of claim 3 wherein the subsequent resume parameters including a new resume identity and a next hop chaining count.

5. The method of claim 1 further comprising transmitting a cause value in the connection resume request, the cause value indicating at least one reason that triggered the connection resumption.

6. The method of claim 1 further comprising receiving a connection resume message from the network, the connection resume message including configuration information.

7. The method of claim 6 further comprising applying the configuration information.

8. The method of claim 7 wherein the connection resume request message is sent to the network via a selected candidate cell.

9. The method of claim 1 further comprising sending a connection resume complete message to the network, wherein the connection resume complete message indicates that the WTRU has resumed the connection.

10. The method of claim 1 further comprising performing a re-establishment procedure if there are no cells included in the list of candidate cells that meet the acceptable threshold signal level.

11. The method of claim 1 further comprising determining the radio conditions of one of the candidate cells from the list of candidate cells meets the acceptable threshold signal level.

12. A wireless transmit receive unit (WTRU) comprising:
a processor; and
a transceiver communicatively coupled to the processor, the processor and transceiver configured to:
receive configuration information for performing a connection resumption upon detection of a radio link failure (RLF), the configuration information including one or more of WTRU identity to be used during a connection resumption procedure, a security configuration to be applied during the connection resumption procedure or at least a list of candidate cells, and an acceptable threshold signal level for a cell to be used;
perform, upon detection of an RLF, cell selection towards one of the candidate cells included in the list of candidate cells with radio conditions that meet the acceptable threshold signal level; and
sending a connection resume request message to a network.

13. The WTRU of claim 12 wherein the receiving is in CONNECTED state.

14. The WTRU of claim 12 wherein the processor and transceiver are further configured to receive subsequent resume parameters of a subsequent resume, the subsequent resume parameters including a new resume identity and a next hop chaining count.

15. The WTRU of claim 12 wherein the processor and transceiver are further configured to include cause value in the connection resume request, the cause value indicating at least one reason that triggered the connection resumption.

16. The WTRU of claim 12 wherein the processor and transceiver are further configured to:
receive a connection resume message from the network, the connection resume message including configuration information;
apply the configuration information; and
resume the connection with the network via a selected candidate cell.

17. The WTRU of claim 12 wherein the processor and transceiver are further configured to send a connection resume complete message to the network.

18. The WTRU of claim 17 wherein the connection resume complete message indicates that the WTRU has resumed the connection.

19. The WTRU of claim 12 wherein the processor and transceiver are further configured to perform a re-establishment procedure if there are no cells included in the list of candidate cells that meet the acceptable threshold signal level.

20. The WTRU of claim 12 wherein the processor and transceiver are further configured to determine the radio conditions of one of the candidate cells from the list of candidate cells meets the acceptable threshold signal level.
